(19) United States
(12) Patent Application Publication
(10) Pub. No.: US 2009/0265225 A1
(43) Pub. Date: Oct. 22, 2009

(54) Transfer methods, systems and devices for managing a compliance instruction lifecycle

(76) Inventor: Melinda Kathryn Puente, Salem, OR (US)

Correspondence Address: Melinda Kathryn Puente, P.O. Box 3194, Salem, OR, 97302, US

(21) Appl. No.: 12/321,336

(22) Filed: Jan. 21, 2009

Related U.S. Application Data
(63) Continuation-in-part of application No. PCT/IB2008/000103, filed on Jan. 18, 2008.
Application No. PCT/IB2008/000103 is a continuation-in-part of application No. 11/654,429, filed on Jan. 17, 2007.
(60) Provisional application No. 61/126,477, filed on May 5, 2008.
(60) Provisional application No. 60/759,318, filed on Jan. 17, 2006.

(30) Foreign Application Priority Data
Jan. 18, 2008 (IB) PCT/IB2008/000103

(51) Int. Cl. G06Q 10/00

(52) U.S. Cl. 705/11

(57) ABSTRACT

An instructional management system using an instructional game to provide support to a compliance learner as they encounter variance during operational execution, require redirection and or intervention and necessitate a metric for transfer, during and within an instructional compliance lifecycle, relative to rules of law, policy, standards of treatment and/or self-assigned parameters.

This application claims priority of U.S. Provisional Patent Application Ser. No. 61/126/477, filed May 5, 2008, entitled, “TRANSFER-TO-PRACTICE SYSTEMS, DEVICES AND METHODS FOR MANAGING A COMPLIANCE INSTRUCTION LIFECYCLE,” and is also a continuation-in-part application of PCT Application Ser. No. PCT/IIB2008/000103, entitled “TRANSFER-TO-PRACTICE SYSTEMS, DEVICES AND METHODS FOR MANAGING A COMPLIANCE INSTRUCTION LIFECYCLE”, filed Jan. 18, 2008, now abandoned, which is a continuation-in-part application of U.S. patent application Ser. No. 11/654,429 filed Jan. 17, 2007 entitled “A METHOD OF AN INSTRUCTIONAL GAME and U.S. Provisional Patent Application Ser. No. 60/759/318, entitled “AN INSTRUCTIONAL GAME PROGRAM AND METHOD” filed Jan. 17, 2006, the teachings of which are incorporated herein by reference.

### FIELD OF THE INVENTION

The present application relates generally to the electronic implementation of instructional compliance management with distributed systems, methods, devices, in particularly, an instructional game is integrated with operations training and execution within a compliance lifecycle.

### BACKGROUND OF THE INVENTION

Within the last decade, research has focused on the significance of human/object interaction, and the consequence of noncompliant practice. In management and the software industry, conformance can mean adhering to and demonstrating compliance to a standard (i.e. code of conduct) or regulation. In medicine, conformance can mean adherence to a recommended course of treatment, and the accomplishment of self-regulation can mean adherence to self-assigned parameter's (i.e. reduce consumption by “x” amount to lose weight or stop smoking). Consequences of nonconformance not only impact the individual but often have significant implications for society.

For example, U.S. Sentencing Commission, Organizational Sentencing Guidelines (2004), states that ethics and compliance training programs must be in place to prevent and detect criminal activity if a company wants to prove due diligence. The consequence of not being able to track and prove individual employee instruction, greatly reduces training as a mitigating factor subsequent to a violation. The World Health Organization (2003) has reported that in developed countries only 50% of

patients who suffer from chronic diseases adhere to treatment recommendations due in part to unclear instructions. Consequences can impact both the patient's immediate health and society (e.g. failure to prevent complications from chronic diseases or formation of resistant infections). The United States GAO (2000) has reported that approximately 29% of US underground storage tanks may not be properly operated and maintained due in large part to a lack in training of tank personnel. A consequence is the potential for an increased risk of a product release to the environment. The National Institutes of Health (2004) report that binge drinking on college campuses has remained unchanged over the last decade despite extensive risk prevention educational campaigns. A consequence is that more than 1.2 million students suffer annually unintentional injury from accidents or altercations and more than 1,400 die in alcohol related events.

While the above domains differ in knowledge structure and involve a plurality of factors that impact conformance, what is universal is the often failure of individuals to adhere to a determinate method, prescribed treatment, standard policy or self-assigned parameter due to a lack of understandability or transfer-to-practice knowledge. Most commonly reported causes for poor conformance involving overall instructions include: regimes too complicated to understand, instructions not clear to execute, purpose of instructions not clear to induce reasoning, physical difficulty in applying instruction and forgetfulness.

To date, the general provision of instructional information appears to have been limited in the ability to transfer conformity and or adherence knowledge to practice. Significantly, nonconformity often leads to an increased potential of harm, loss or damage and subsequent litigation and/or claims of compensation that not only impact the individual, but often have significant implications for society as a whole.

Accordingly, it will be appreciated from the foregoing, there is currently a need in the art for improvements in compliance instruction transfer to practice management.

### SUMMARY OF INVENTION

An instructional management system using an instructional game to provide support to a compliance learner as they encounter variance during operational execution, require redirection and or intervention and necessitate a metric for transfer during and within an instructional compliance lifecycle relative to rules of law, policy, standards of treatment and/or self-assigned parameters.

In one embodiment a technological advantage of the present invention is the implementation of an extended morphological analysis processing method for the rapid generation of object and path determination, strategy and scenario development, performance assessment, analysis and communication for implementing an indicative instruction component, a response component, a detection component, an iterative instruction component, a measurement component, a recording component and a customization component.

In another embodiment a customization component can be used to determine a morphology of parameter dimensions that can generate a transfer system architecture via a graphical user interface (GUI). In another embodiment, a customization component can access user object images that can then be correlated to system features.

In another embodiment, the indicative instruction component can include an instruction/game, incorporating a tiered-approach for delivering and assessing a priori compliance knowledge and a posteriori transfer-to-practice.

In a further embodiment, a detection component can detect a posteriori transfer-to-practice variance during instruction processing and operation execution.

In a further embodiment, a responding component can respond to a user subsequent to a posteriori transfer-to-practice variance detection, to inform, notify, redirect, warn or communicate a support response.

In a further embodiment, an indicative component for assessing a posteriori transfer-to-practice variance, provides a user with a specific response regarding performance, results and loss subsequent to variances indicative of noncompliance.

In a still further embodiment, a measurement component can be used to measure at least one morphology set and/or parameter within a morphology set.

A further embodiment, a recordings component can record variances, predetermined or required responses and metrics.

A further embodiment integrates the various components within the compliance lifecycle into a management tool that provides support to a compliance learner as they transition from a priori to a posteriori, encounter variance during operational execution, require redirection and or intervention and necessitate a metric for transfer-to-practice morphology.

Other devices, systems, methods and features of the invention will become apparent to one with skill in the art upon examination of the following figures and detailed description. It is intended that all such additional systems, methods, features and detailed description, be within the scope of the invention, and be protected by the accompanying claims. The following exemplary embodiments are provided as examples only of the present invention. Accordingly, the scope of this invention is not limited to the presently described embodiments.

To illustrate the present invention, in which examples or references to standard processes, include rules of law in particular, underground storage tank (USTs), prescribed treatments, in particular, HIV, TB, wound care, smoking and obesity and policy references, in particular, applying for a car loan and warranty follow-up, are provided as exemplary processes only, to demonstrate the usefulness of the invention. However, those with skill in the art will recognize alternative designs, embodiments, modifications and applied examples to other domains for transfer-to-practice compliance, including those which may be part of conformity with other rules of

### BRIEF DESCRIPTION OF THE DRAWINGS

The accompanying drawings, which are incorporated in and constitute a part of this specification and, together with the description, explain the objects, advantages, and principles of the invention. In the drawings:

FIG. 1 is an illustration of operating environment in conjunction with which the transfer-to-practice system of this invention may operate.

FIG. 2 is a block diagram depicting an exemplary embodiment of a compliance instruction transfer-to-practice management tool.

FIG. 3 is an illustration of an embodiment of a compliance instruction transfer-to-practice management apparatus integrating the tool of FIG. 2 and method of FIG. 4.

FIG. 4 is a flow diagram depicting an exemplary method of implementing the transfer-to-practice apparatus in FIG. 3 on a temporary dermal device.

FIG. 5 is a flow diagram of a method of applying a temporally dermal device for compliance assistance.

FIG. 6A is a flow diagram depicting a method of managing transfer-to-practice compliance within a compliance lifecycle period in which customization, and operations monitoring and recording are integrated.

FIG. 6B is a flow diagram depicting a method of managing transfer-to-practice compliance within a compliance lifecycle period in which an a priori level of an instruction/game is integrated within FIG. 4.

FIG. 6C is a flow diagram depicting a method of managing transfer-to-practice compliance within a compliance lifecycle period in which structured a posteriori levels of an instruction/game is integrated within FIGS. 3 and 4.

FIG. 7 is an illustration of a customization/development graphical user interface for generating a user specific, transfer-to-practice system.

FIG. 8 is an illustration of a customization/development graphical user interface for generating a user specific, transfer-to-practice system.

FIG. 9 is a flow diagram of a development method for generating a user specific, transfer-to-practice system.

FIG. 10 is an illustration of operations monitoring, depicting a method of managing transfer-to-practice compliance within a compliance lifecycle period.

FIG. 11 is an illustration of operations record keeping, depicting a method of managing transfer-to-practice compliance within a compliance lifecycle period.

FIG. 12 is an illustration of a method of customizing the transfer-to-practice system through a static or dynamic image with a user site-specific object or image and setting advisory mode prior to self-monitoring.

### DETAILED DESCRIPTION OF THE PRESENT EMBODIMENT

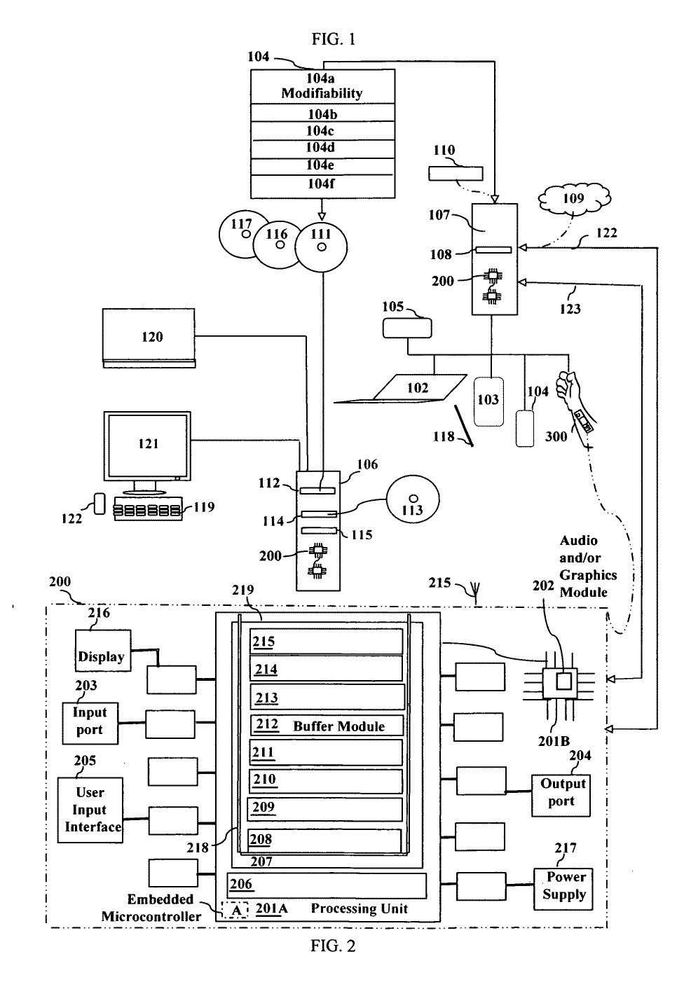

Provided herein are transfer-to-practice methods, systems, devices and computer readable medium for the management of compliance lifecycles. FIG. 1 is an illustration of operating environment in conjunction with which the transfer-to-practice system of devices, 200, 300, methods and computer-readable mediums 104 a-f, of this invention may operate. The system preferably includes various configurations which may be implemented by means of software, for such transfer-to-practice devices using microcode, or within a network or portal, firmware, middleware for 104 a-f via bi-directional communication paths to wireless devices that can include, computers 102 personal digital assistant (PDA) 103, cellular telephone 104 and/or game console 105.

Further transfer-to-practice components can be accessible to hardware, such as computers 106 and 107 by reconfigurable tools 200A and 200B. As used herein, the hardware system of these embodiments can include a field programmable gate array (FPGA), discrete gate or transistor logic, a discrete semiconductor device, an application-specific integrated circuit, a digital signal processor (DSP), other discrete hardware components, or any combination thereof, and/or a processing platform 200.

A software system can include can include one or more objects, agents, lines of code, threads, subroutines, a module, a software package, a class, or a combination of instructions, data structures, or program statements, databases, application programming interfaces, web browser plug-ins, or other suitable data structures, and can include two or more different lines of code or suitable data structures operating in two or more separate software applications, on two or more different processing platforms, or in other suitable architectures. In one exemplary embodiment, a software system can include one or more lines of code where coupled other code segments or hardware circuits by passing and/or receiving parameters, arguments or other such data information operating in a general purpose software application, such as an operating system, and one or more lines of code or other suitable software structures operating in a specific purpose software application. In another exemplary embodiment, a software system can be implemented as a distributed software system where parameters, arguments or other such data information may be transmitted, forwarded or passed via a network transmission, memory sharing, token passing, message passing or in other suitable manners.

As illustrated in FIG. 1, additional hardware and network environments in which the transfer-to-practice tools may operate may include a Local Area Network (LAN) 122, a Wide Area Network (WAN) 123. Applicable to a conventional computer or any other type of computer such as a remote memory storage device 108 within the remote computer or server 106 can store data from the illustrated programs and modules, relative to processing units within the networked environment by means of the digital devices (102, 103, 104, 105, 300) an/or by means of other wired and/or wireless communications network. However, it is appreciated that the network connections shown are exemplary and other means 109 (i.e. Bluetooth, IEEE 802.11, infrared IT, SIP standards, ZigBee, infrared, mobile communication standard, WCDMA, GSM Communication radio, microwave and communication devices 110 to include, routers, fiber optic cable, a coaxial cable or digital subscriber line (DSL), for establishing a communications link between the transfer-to-practice systems, devices, methods and computer-readable mediums may be used.

Computer-readable medium and storage of multiple program modules, application programs, and program data, can be carried out on digital versatile disk (DVD) drive 112 for reading from a removable DVD 111, a hard disk drive 112 for reading from and writing to a hard disk and an optical disk drive 113 for reading from or writing to a removable optical disk 114 such as a CD ROM or other optical media. The DVD drive 112, hard disk drive 115 and optical disk drive 214 coupled with respective drive interfaces. Further, laser discs 116, or Blu-ray disc 116, magnetic disk storage mediums, read-only memory (ROM), random access memory (RAM), flash memory devices, optical storage mediums, EEPROM, CD-ROM optical, magnetic, or other combinations, within 102, 103, 104, 105, 106, 107, 110, 201A, 201B and other such configurations.

Peripheral input devices such as a keyboard 119, pointing device 118, mouse 123, (or where an is interface configured to communicate with a voice recognition, touch screen or panel, button, switch, combination, wheel/button may be used to roller ball, or trackball, not shown) may be used to enter commands. Further, input devices and ports can include, television 120, a monitor 121.

Referring now to FIG. 2 is a block diagram that illustrates an operative configuration 200 that is pertinent to the operation of apparatus 300 and transfer-to-practice method 104a-f in accordance with the second and third embodiments of the present invention. The components include a processing unit 201A and 201B, memory 219, an input 203 and output device 204, a user input interface and a communication interface 215, a display 216, a power supply 217 and a bus configuration.

The processing units 200A and 200B which can include a field programmable gate array (FPGA), where such processing units as 200A typically perform with a general purpose processor, one or more processing units as its processor, an embedded microcontroller (A) and a computer-readable medium such as storage means 219 in which the various modules and database 206-215, logical blocks, functions, circuits, elements, and/or components described in connection with the examples disclosed herein may be implemented in the form of programming instructions, directions, processing units, self-contained in a single device or distributed across multiple devices. Algorithms to include morphological analysis processing and methods (e.g. instructional game, monitoring, recording and customization) disclosed herein for exemplary embodiments, may be encoded in a software module executable by a processor 200B and 200A or embedded directly in hardware 200A or any combination thereof and the like.

Communication interface 215 can be configured to communicate externally in any desired manner [0033], preferably device 200, operates in an combination [0033] environment using Session Initiation Protocol (SIP) and Real-time Transport Protocol (RTP) for executing “push to talk.” Input device 203 can be a group of sensors which can include, digital, laser, radio microwave, infrared, RFID, PIR, accelerometer, piezoelectric, temperature, ultrasonic or any and all such electronic devices or combinations thereof which aid a learner/user/player and in some events a machine, detect or be notified regarding a variance in compliance.

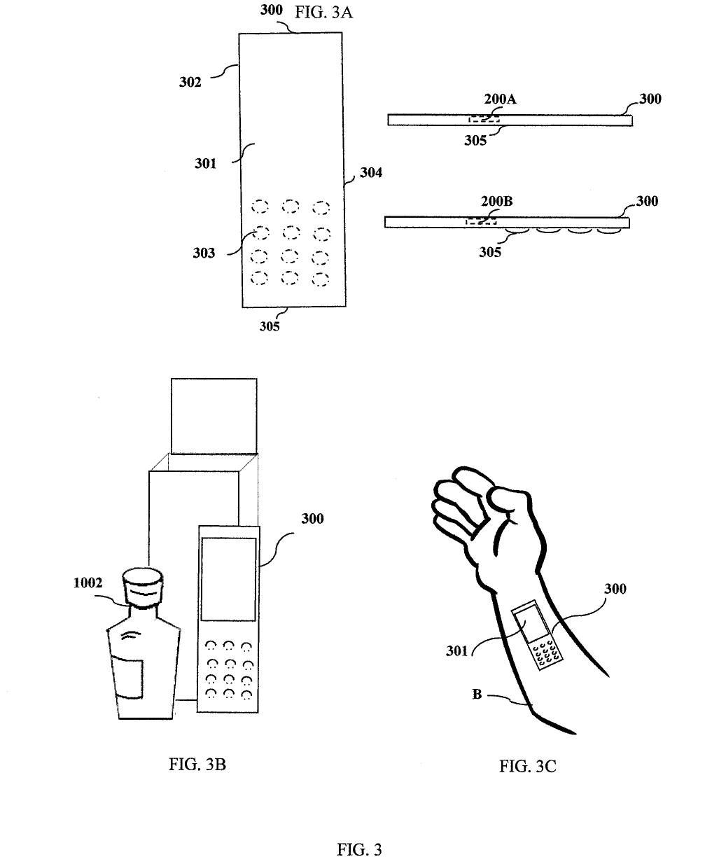

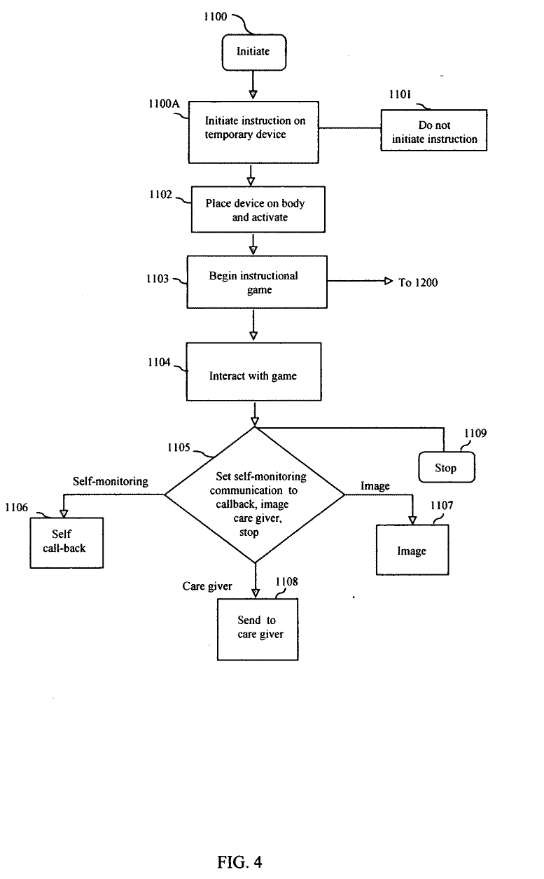

FIG. 3 is an illustration of an embodiment of a compliance instruction transfer-to-practice management apparatus integrating the tool of FIG. 2 and method of FIG. 4. According to one embodiment of the present invention, a temporary dermal communication apparatus 300, preferably configured to be wearable on a user/learner/player (B), or in some circumstances used by a machine. The temporary dermal communication device 300 operates as wireless communication and includes a user/learner/player (B), or in some circumstances used by a machine. The temporary dermal communication device 300 operates as wireless communication and includes a display 301, (that can include but is not limited to displays as liquid crystal (LCD), light emitting device (LED), organic light-emitting diode (OLED), Active-Matrix OLED (AMOLED), phosphorescent organic light-emitting diode, field emission display (FED), SED (surface-conduction electron-emitter). The display configuration preferably takes into account power requirements, size and space in the actual implementation.

Further speakers 302 for both listening and speaking, an interface unit 303, and a pliable package (to include processing 200 by means, circuitry, conductors and solar cell energy source (that can include one or a combination of minuscule fabrication or nanotechnologies for polymer solar cells, photovoltaic, biomimetics, quantum dot, hot-carrier cells, upconversion tandem/multi-junction cells, and or solar thermal technologies enhanced with simple or compound lens prism optics (e.g. fresnel design), within a colloidal silicon substrate 304, cover face configuration of silicone or a combined melanin/cellulose fabrication 304, and colloidal melanin back with an adhesive 305 stripping in some circumstances which can include a micro perforation process for configuring a polydopamine adhesive layer 306. All components and pliable package 300 can be manufactured in an combination assembly-line type, spin-casting configuration method utilizing rotational force and UV light curing integration at between 265 nm and 400 nm.

In FIG. 3B an illustration is depicted, of the administration of medications for achieving compliance at a specified time deemed critical to prevent the occurrence of new multi drug-resistant cases as well as measures to control existing cases (i.e. HIV and TB). As it relates to the present invention, treatment information can be delivered through an instructional game application, regarding a step-by-step treatment regime, simulations of care and consequences of adverse effects as previously described in game sequences to include a demonstration and simulation instruction and aerial field map monitoring and notification.

Referring now to FIG. 3B, there is shown an illustration of a second exemplary embodiment of a temporary dermal communication device and operating environment in conjunction with which the instructional game of this invention may be practiced. The use of the temporary dermal communication device accompanies a medication prescription.

Referring now to FIG. 3C, there is shown an illustration of a third exemplary embodiment of a temporary dermal communication device and operating environment in conjunction with which the instructional game of this invention may be practiced. The protective covering from the back of the device is removed and then placed on the underside of the patient's forearm.

Referring now to FIG. 4, there is shown a method for describing a method for a temporary dermal communication device according to an exemplary embodiment of the present invention. As the care giver assists the patient with instruction regarding the specific treatment regime, as step 1101 begins with the initiation of instruction on the temporary device. At 1102, the device is placed on the human body, on the skin or a band and activated.

At 1103, power activation is implemented and the patient views instructional presentations regarding the task of compliance with treatment regime at a set time and the expected consequences if patient should not adhere to the regime. Here, the instructional game can be presented directly by a device configuration or technology convergence configuration using the internet, telephone, television or wireless connection.

In a second exemplary embodiment, the patient can interact through human/machine interaction during the instructional game in step 1104. In a third exemplary embodiment, upon completion of the instruction in step 1105, the care giver assists the patient set the self-monitoring feature which can include a self assigned callback message, step 1106 that is set to occur at the designated time and a image from the aerial field map, step 1107, that will continue to activate should the patent not enter the appropriate time confirmation in response to compliance notification. Should time exceed a predetermined interval, the notification call-back can also be set to communicate with the care giver in step 1108.

Customization

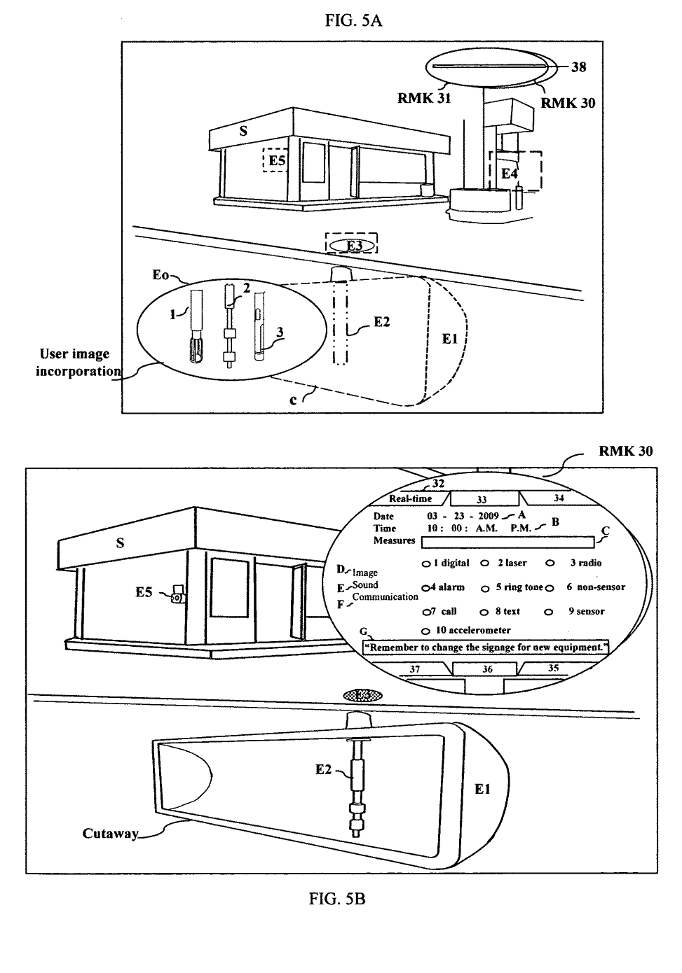

Access to the transfer-to-practice system can be initiated by means of user interface. FIGS. 5A, 5B, 11, 12 and 13, show an illustration at 30, of a user interface hereafter referred as resource management key, (RMK). The purpose of the RMK 30 in the present invention, is to provide a method of accessing all the transfer communication tools, functions and utilities as well as providing a continuous tracking or metric for virtual or real-time resources.

One embodiment of the RMK 30, illustrated in FIG. 5B, depicts access controls. The controls include access to a priori and a posteriori instruction support for: Instruction/game tools 32, Procedures and Task visualization 33, User/Objects 34, Status 35, Loss 36 and Reporting 37.

A second embodiment of the RMK 30 at FIG. 5A, is RMK 31, where the rendering of virtual or real-time resources is displayed, resultant of a variance in performance. Variance is represented by means of communication (e.g. rendered lines relative to loss gravity.) For exemplary purposes, line 37, is representative of personal financial loss, line 38, is representative of loss due to human or environmental harm, while line 39 is representative of third-party financial loss.

For example, when the performance by the user/learner or player is determined to be variant from the original or determined instruction, a reduction of line length 37 occurs to the right (indicated by the direction of arrow 1); whereas non-variant performance shows no line movement. Variant performance can also result in the appearance of lines 38 and 39 and/or lanes 37c, 38c, 39c.

A further embodiment of the RMK 31, is to display the virtual or real-time resources that are tracked subsequent to performance, results and loss. Within FIG. 3B, the lanes, 37c, 38c, 39c between lines 37, 38 and 39, are swimlane tracking consistent with the critical chain method (CCM), of virtual resource loss. In one embodiment, swimlane data can be exported to a user preferred system. Additionally, the tracking of performance, results and loss correlate to internal n-dimensional aggregates (e.g. “morphological box” or OLAP) for methods of data mining.

Within the transfer tools that are in operation, the RMK 30, provides access to a customization module for identifying and defining user-specific images, determining communication preferences, means, methods and notice content. A second customization functionality is provided by a code generator tool within the core architecture.

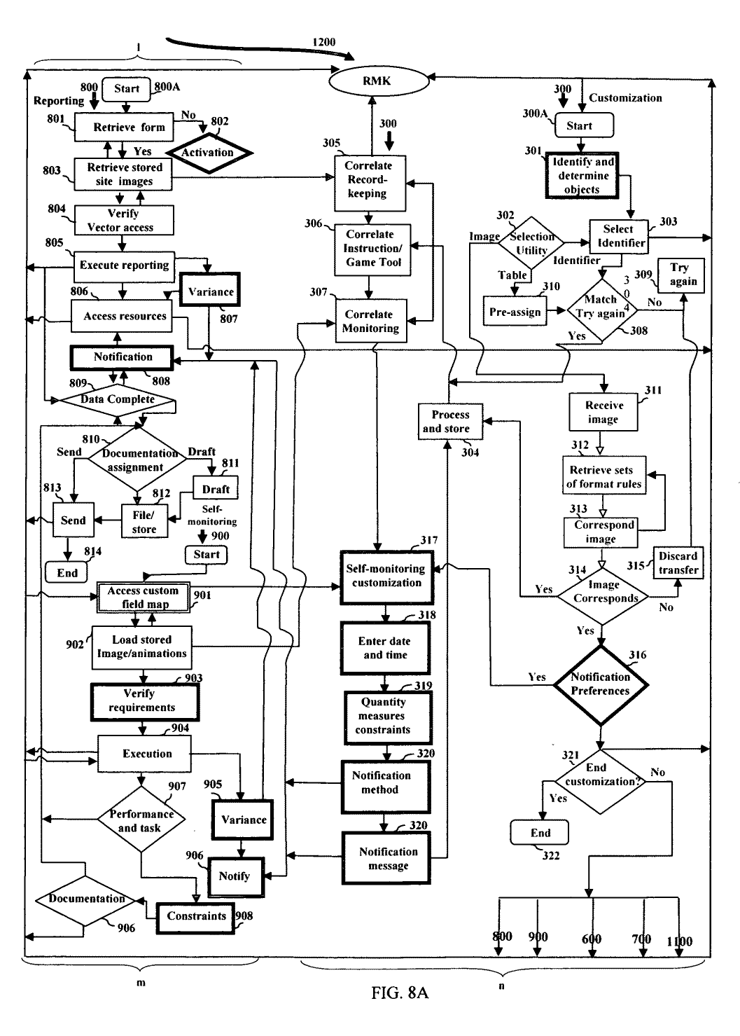

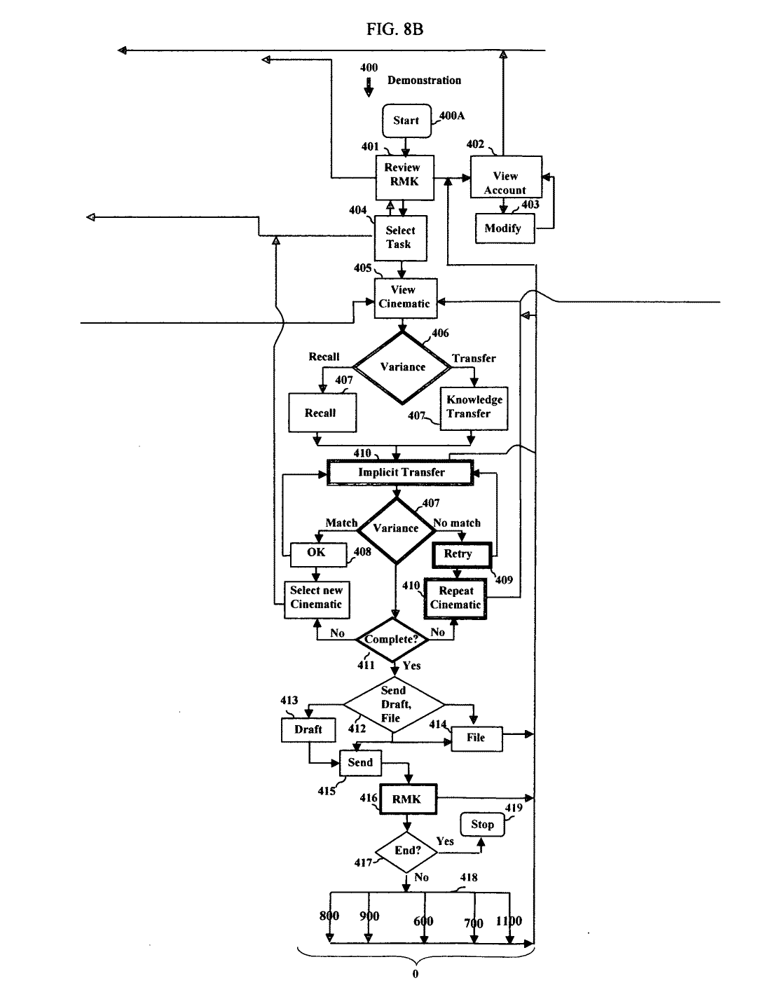

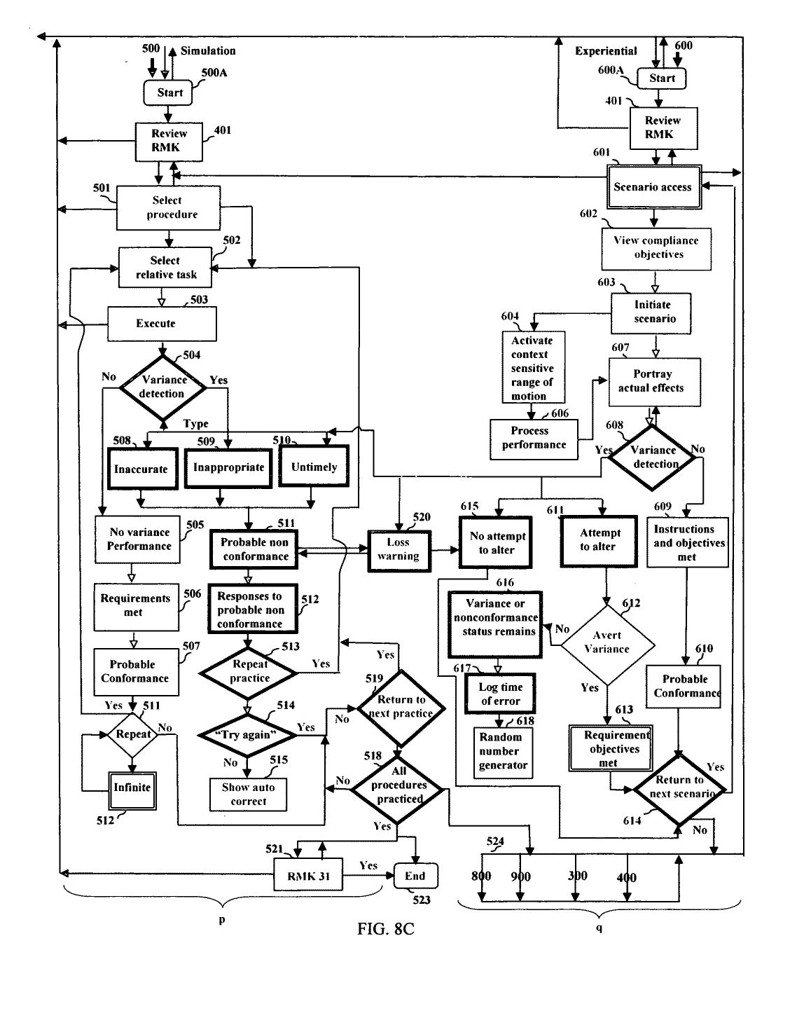

Referring to FIG. 8A there is shown at 300, a logic flow chart or mode processing. Here, throughout the transfer system processing, as illustrated in FIG. 8A-FIG. 8C, all human interaction (e.g. selection, a response, a play, an interaction) is a submission to the system relative to compliance.

Returning now to the customization mode 300 at FIG. 8A, the system enables access to user specific objects through a predetermined lexicon, digital image, or sensor signal, to enhance familiarization with instruction content and to identify and determine notification preferences.

In one exemplary embodiment, illustrated in FIGS. 5A and 5B, to identify overfill protection equipment (abbreviated as a symbol “Eo” in the figure), three devices are permitted; an overfill alarm system, shut-off device or ball float valve as presented within the cutaway at “C”. By accessing the overfill devices of choice utilized at the user's facility, the selected equipment component(s) are placed within the tank.

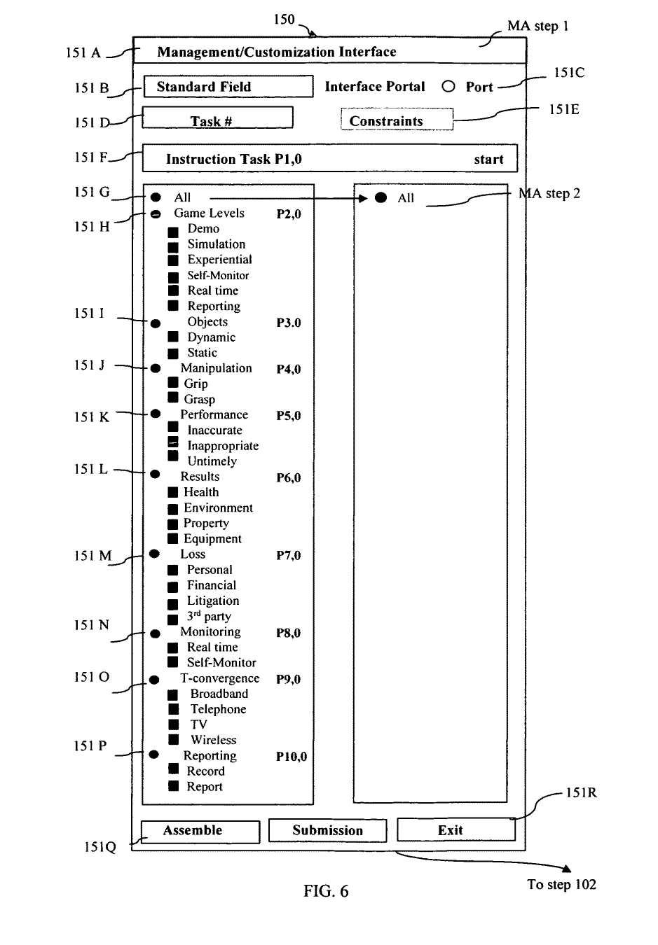

At the completion of the customization process, all of the site specific equipment selections will appear within the represented site facility. For example, FIG. 6B, now includes: “E1” a fiberglass tank, “E2” an tank probe, “E3” a fill cover, “E4” a three nozzle dispenser and an alarm located outside the facility at “E5”, as it will appear in the RMK 30. The following is an example flow diagram of this process in the customization module 300 at FIG. 8A.

If the customization decision is to utilize the rendered instruction/game tool identifiers 30 (i.e. “E0” in FIG. 5A) the user can interact (e.g. by means of a mouse, stylus, touch screen, or voice), with an image 304 to process the image into the RMK 30 (i.e. 5A) or instruction/game mode space (i.e. 5B). If the image 304 is determined to correspond to the determining (original) stored object image, a correlation is made between the matched predetermined sub-image and stored equivalent instruction/game tool image feature at 306, the object image reporting feature at 305 and the object image self-monitoring feature at 307. When the learner/user/player is satisfied with object selections the objects are processed 306. If there is no match at 308 with the identifier, a prompt to try again occurs at 309.

Another embodiment provides for the importing of an image into the object field of the RMK 30 customization screen. When the image is retrieved 311, a set of format rules 312 corresponds to the stored format 313 when retrieved 311. The resulting sub-image of the site-specific image (equipment) is subsequently processed to predetermined parameters of an equivalent sub-image BB of the same object image (equipment) retrieved from a conversion library and matched to the vector location of the image mapped to an equivalent object images in 312.

An evaluation algorithm is used to determine whether the transferred image corresponds 314 to the stored equivalent image 304. If the transferred image 314 does not correspond to the stored image 304, the transferred image is discarded 315, does not appear within the RMK 30 and a notification prompt “to try again” 309 occurs.

Additional object images (not within view) are also available from a predetermined lexicon and object image resource table 310. Access to the images can be retrieved from the object menu within the RMK 30. If the user accesses a look-up table at 310, a search for a matched at 308 to the user image is processed at 306. If valid, the image is stored at 304 and subsequent processing is carried out at 305, 306 and 307.

Further customization pertaining to notification preferences and variance, can be carried out in advisory mode when self-monitoring is planned in real-time. For example, FIG. 5C, illustrates an exemplary notification screen within the RMK 30. Here, procedure/task selection can be correlated with required date “A”, time “B” and threshold measures “C” (i.e. location) as applicable with the option of notification preferences “D”. Preferences can include, but are not limited to image “E” sound “F” or communication “G” as illustrated in FIG. 5C.

For example, the user imports an image file from images which can include a digital, laser, radio microwave, bar code and an analysis is made as to whether the transferred image corresponds to the stored equivalent image and pre-assigned quantity parameters. If parameters match pre-assigned restrictions player may wish to be notified. If on the other hand parameters are exceeded or are about to be exceeded, user can be provided with communication that serves as an intermediate intervention to the pre-assigned parameter restriction.

At the completion of customization, the user is prompted 321 to end the customization mode where processing stops 322 or access to additional transfer-to-practice tools at 32 of the RMK 30 at 400 demonstration, 500 practice simulation, 600 experiential, record keeping 800, self-monitoring 900 or attachable instruction/game tool at 300.

A second customization/development functionality is provided by accessing the code generator within the core architecture by means of a second vector-based interface. The illustration at FIG. 3, shows a user graphical user interface (GUI) 150, here represented as vector-based GUI.

When GUI 150 is accessed within the RMK 30, only the upper portion “U”, of the GUI 150 appears within the RMK 30. The GUI 150, provides dialogue boxes for instruction entry 151F, and when within assigned transfer-to-practice tools, morphological configurations can be selected to display parameter and dimensions individually at P2,0-P10, 0 and 2,1-10,2) and 151H for customized configuration.

When GUI 101 is directly accessed, the vector-based GUI 151, can provide dialogues for instruction entry 151F by means of text, signal or iconic interactions. For example, when the port/portal button 41D is selected, mapping to selected configurations for preferred network access and peripherals is displayed. When the determining parameter and relative dimension button at 151G is selected, the user is presented with a menu of determining parameters and dimensions (P2,0-P10, 0 and 2,1-10,2). Similarly, defined morphological configurations can be selected to display parameter and dimensions individually at P2,0-P10, 0 and 2,1-10,2) and 41H, respectively.

When the dialogue boxes for 151B domain and constraints 151E are accessed, the user is provided additional structures to support specific transfer-to-practice tool development within the core architecture. However, the core is operable for real-time use without domain or constraint selections based on morphological reconfigurations within the n-dimensional array and the default values within the core architecture

Basically, the development GUI 150, provides the user(s) with the capability to generate code configurations for transfer-to-practice tools which can include a system, module, application or computer program) by defined needs, using primarily, a core of interchangeable assembly language/machine readable source code. By means of user manipulation, morphological configurations within blocks and/or modules, facilitate the generation of source code configurations. Modification of the core into preferred or required tools connected by arbitrary pieces of code and subroutines may also be used to construct customized tools.

GUI 150 is operable and communicatively coupled to the core architecture. The core architecture comprises one at least three n-dimensional arrays generated from processing methods of a morphological analysis algorithm (MAA), based on Dr. Fritz Zwicky, 1957 and 1969 herein incorporated, in which components of number theory, geometry and visualization are integrated.

The present invention herein incorporates and extends these components and MAA, in which a plurality of transfer-to-practice tools and methods are configurable from the core architecture. A characterization of the core and processing functionalities include, matrix generation via parameterization for solution space, use of extended n-dimensional fields or aggregates whose axes correspond to determining parameters for analysis, integrated construction of topological performance visualization and iterative feedback for a priori, a posteriori instruction, performance assessment during execution, notification triggers upon variance, monitoring and reporting are herein incorporated and extend the resultant componentization and orthogonal configurations in n-dimensional arrays, in which object and path determination, strategies and scenarios for development, performance assessment, variance analysis and multiple play service provisions are generated.

As the heuristic method of MAA is extended within this invention: (A) heuristics applicable to the instruction/game mode use a method of teaching that encourages learners to discover solutions for themselves; (B) heuristics applicable to system functions, where the method of core code generated from MAA processing, reconfigures in response to the user; (C) heuristics applicable to assessment logic during operations, where the method of variance in condition is probable, but not necessarily a proof, are herein presented below.

The first two steps of a five step morphological analysis algorithm, are the designation of a problem (MAA 1, at 150) and the subsequent creation of an extensive solution space (MAA 2, at 151). As these processes relate to this invention, the designation of the problem area is a variance in pre-a priori, a priori and a posteriori instruction during performance. And the selection of mitigating parameters and relevant object matrices that might influence non-variance by the non-limiting means of visualization of causal-spatiotemporal criterion, notification and loss configured within a solution space.

There is shown at 151G, at least one of a combinatorial of determining parameters. Field parameters include: (P1a,0) single task entry by standard, indexed to type of (P2b,0) cognitive construct state correlated to instruction/game tool level, (P3c,0) type of object, (P4d,0) type of gesture hand/manipulation, (P5e,0) type of performance, (P6f,0) type of result, (P7g,0) type of loss, (P8h,0) type of monitoring, (P9i,0) type of technology convergence, (P10j,0) recordkeeping, self-monitoring.

Associable with the above listed array of dimensions, parameters and/or values, are at least one of a combinatorial of relative object dimension matrices including: (1,1) specific instruction by task entry (P2b,0) cognitive constructs to support a priori and a posteriori instruction execution, (2b,1) understand, compare, Demonstration, (2b,2) analyze, evaluate, Simulation practice, 2b,3) apply, create, Experiential, (2b,4) remember, Monitoring, (2b,5) meta-cognitive, Real-time monitoring and (2b,6) meta-cognitive, Recordkeeping meta-cognitive, (P3c,0) type of objects utilized in task/procedure (3a,1) static or (3c,2) dynamic, (P4d,0) hand gesture with object, (4d,1) grip, (4d,2) grasp (e.g. all hand appendage configurations with extended thumbs and/or fingers), (P5e,0) performance, (5e,1) inaccurate, (5e,2) inappropriate or (5e,3) untimely, (P6f,0) results (causal spacio-temporal criterion), (6f,1) health, (6f,2) environment, (6f,3) property or (6f,4) equipment; loss (P7g,0) Personal (7g,1), financial (7g,2) Litigation (7g,3), 3^{rd} party (7g,4), monitoring (P8h,0), pre-monitoring (8h,1), real time (8h,2); technology convergence (P10j,0), broadband (9i,1), telephone (9j,2), television (9j,3) and wireless (9j,4), (P10j,0), reporting, recordkeeping (10j,1) reporting. Those skilled in the art will appreciate while the above array of parameter dimensions represent factors that can influence instruction delivery and resource management, a further extension of the parameter dimensions will not change the scope of invention.

Upon selection of a problem space and determining parameters and matrices (i.e. 101G), the third step of the morphological analysis algorithm is to set the parameters and objects against each other, in parallel. The first extension of the MAA process, as used in the present invention is the computer-assistance or parameterization of 101G, where at least a combinatorial of at least two or all of (P1a,0-P10j,0 . . . n) and objects (1a,1-10j,2 . . . n) are configured in an n-dimensional array at 102 in FIG. 2B.

facilitate visualization of interconnected relationships. An extension of this MAA step, as used within the present invention, is for analysis of cause and effect or causes that affect (cognition, performance, loss), internal consistency (cognition, performance, T-convergence), aggregated visualization of consequences (performance, results and loss) and evaluation (cognitive, performance, results) when tracking and data mining.

A second extension of this method as used in the present invention, is the generation of the configurations in transposed n-dimensional arrays, (i.e. by column and by row). Utilization of the resultant configuration vectors in the arrays, (i.e 1,0, 2,0, 3,0 . . . n) and morphological derivatives, (i.e tas, con, obj . . . n) generate a reconfigurable core of interoperable machine/assembly language. The interoperability of this language combined with the transposed arrays, provide a further embodiment for preferred encryption.

In contrast to MAA processing, which often selectively determines chains or configurations. One embodiment of this invention is to extend the aforementioned MAA processing method, in which the generation of configurations indexed by the accurate sequence ordering of an instruction, transforms into a plurality of configurations of variant ordering, in transposition n-dimensional arrays.

Another embodiment within the present invention is to, (1) store all the configurations in the matrix which are used to create object and path determinations for the system and (2) to retain the configurations in the path set order generated during the parameterization step. To obviate bias, (i.e. a limiting of the generated MAA during construction of all phenomenon, that is sometimes caused by a single indexing process), is provided for, in the system's iterative feedback loops (hereafter memory buffers 212), at (a) instruction, (b) practice, (c) performance (d) variance (e) notification, (e) re-try (f) retrain (g) re-practice (h) n-performance after retraining and (i) n-fault notification, illustrated in FIG. 1D, at steps 317, 318, 319, 320, 321, 407, 409, 504, 513, 514, 608, 611, 802, 805, 806, 807, 905, 906, 1104, 1107, 1108, respectively. 317, 318, 319, 320, 321, 407, 409, 504, 513, 514, 608, 611, 802, 805, 806, 807, 905, 906, 1104, 1107, 1108, respectively.

Further, the generated configurations, hereafter referred to as a path set, contain primitives, hereafter referred to as the system micro level, whose axes correspond to the various determining (P1a,0-P10j,0 . . . n) and objects (P1a,1-P10j,2 . . . n), hereafter operated and referred to as the core. The path sets and primitives within the vector-based core, facilitate the generation of object and path determination for strategies and scenario development, to thereby provide for topological performance mapping with performance assessment, probable analysis and date mining (by means of n-dimensional array 3), by means of n-dimensional aggregates whose axes correspond to P1a,0-P10j,2, and multiple play service provision for signal communication by means of a transposition n-dimension array 2.

A further embodiment of the present invention, is the mapping of all primitives on a determined (i.e. accepted) behavior as represented by the task instruction 1a,1. Herein, this establishes a consistency in which determined and variant spacio-temporal criterion (i.e. decision) are identified and acted upon.

A further processing as applied, in the present invention, in which each partition within the path set, has a nonzero value where (P1a,0-P10j,0 . . . n) and objects (P1a,1-P10j,2 . . . n), are predetermined or weighted by assessed gravity as compared to the distance from P axes (P1a, P2b, P3c, P4d, P5e, P6f, P7g, P8h, P9i, P10j), of the correct performance of an instruction (a zero value) While set thresholds are required for real-time utility, the aforementioned determinations are provided core default values (so that the instruction in the game can occur without user-specific assignment).

The morphological analysis processing step in the present invention, where partitioned vectors are determined by the dimension of time, is extended by critical chain method (CCM) in a fifth embodiment. For those with skill in the art, CCM is based upon both predetermined time and resource dependencies, where the required duration time for each task is computed to occur in half or (0.50) less time.

time and resource dependencies, where the required duration time for each task is computed to occur in half or (0.50) less time. Thus, during CCM assessment, computation of the user's performance, by time duration, is calculated at completing the task in less than or equal to half the time (≦0.50) pre-assigned during development, or (0.050 for the default value) and computed with the appropriate performance score and or combined with the determined array of parameters and respective matrices in the compliance scheme where assigned.

For example, aggregate tracking for instruction/game tool Level 1, is determined by the correct recall and task transfer to practice knowledge assessment. As critical chain method (CCM) is determined to be the normative standard upon which timely and or inappropriate (a priori sequence) user/learner performance is assessed for Practice and Experiential levels. The CCM algorithm is used to determine instruction transfer duration based upon both time and resource dependencies, continuous monitoring of the user/learner performance, resource loss and tracking of key and non-significant actions within the instruction transfer and performance scenario. In addition, CCM enables future stochastic predictions. Deviations from the normative order of the a priori path set, results in untimely performance and a lower aggregate. New steps not in the critical chain are determined to be inappropriate and also result in a lower aggregate.

In contrast, the inverse of correct procedure and task steps are combined in an impact matrix to generate incorrect scenarios. User/learner performance contrary to normative path set, are incorrect and cause reduction in the user/learner aggregate score. While qualitative assessment (e.g. probable compliant or noncompliant) of consequences are presented to the user/learner for comparison, checking and critique against normative standard representation, all inappropriate (5e,1), untimely (5e,2) and incorrect (5e,3) performance results (6f,1, 6f,2, 6f,3, 6f,4) in consequences that are correlated with resource loss (7g,1, 7g,2, 7g, 3, 7g,4).

A fourth morphological analysis processing step, is the construction of graphically represented topological performance charts to enhance visualization. For those with skill in the art, a topological performance chart can be a

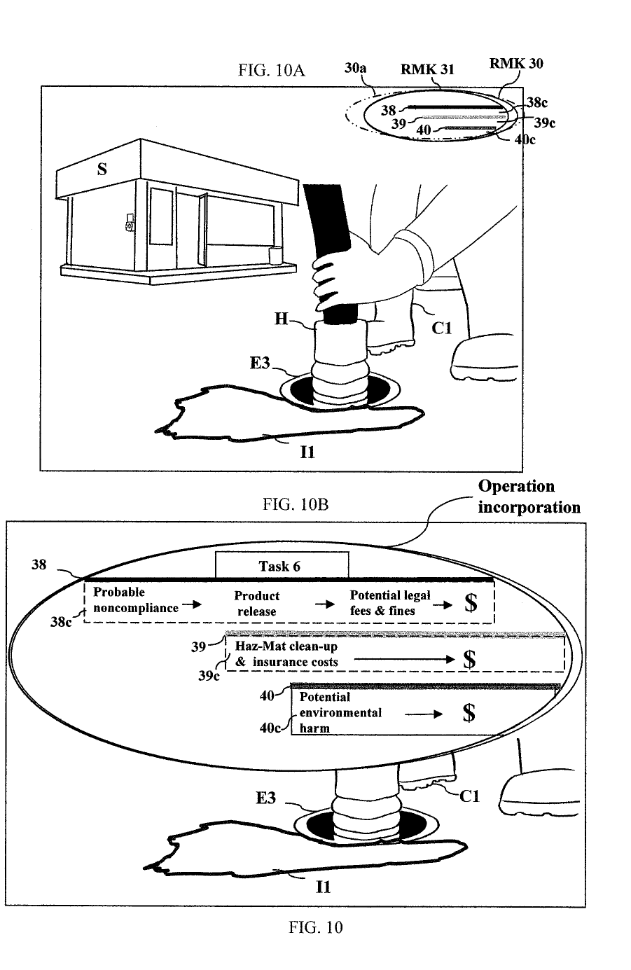

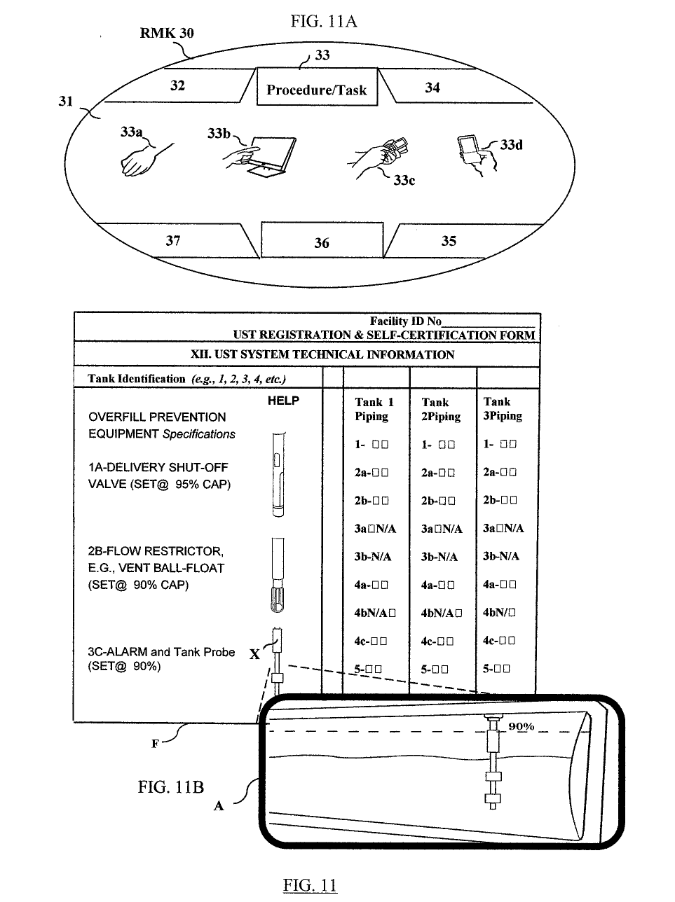

A fourth morphological analysis processing step, is the construction of graphically represented topological performance charts to enhance visualization. For those with skill in the art, a topological performance chart can be a diagram displaying detailed information or “a map to navigate by”. As it pertains to this invention both formats are utilized. In particular, field maps 2b,5, indexed in particularly to P5e,0, P8h,0, P9i,0, can serve as maps to navigate by, prior to a instruction as illustrated in FIG. 11, or as a display after user performance as illustrated in FIGS. 10A and 10B. Further, use of topological performance displays herein, are the “lanes” of swimlanes in the RMK 31, as an aggregate presentation of performance, results and loss, after user performance.

A further extension of the aforementioned MA processing method, herein integrates and extends the graphical representation of topological performance via overlays in P3c,0, and P4d,0 mapped to consequence P7g,0, visualization in orthogonal presentations of instruction/game tool levels P2b,0 reporting P10j,0 and monitoring P8h,0 operation applications linked to the transposition n-dimensional arrays and morphological box, to thereby provide for signal communication with devices and peripherals.

The fifth morphological analysis processing step, is the execution of all solutions generated from MA. As it pertains to this invention, buffers for supporting visualization of desired transfer to practice, is facilitated by multimedia and multimodal means, in which an instruction/game tool, modules for reporting and self-monitoring operation, customization module and attachable instruction/game tool are reconfigured from a core architecture. Here, the interoperability of the primitives are indexed to corresponding vectors in the modeled space.

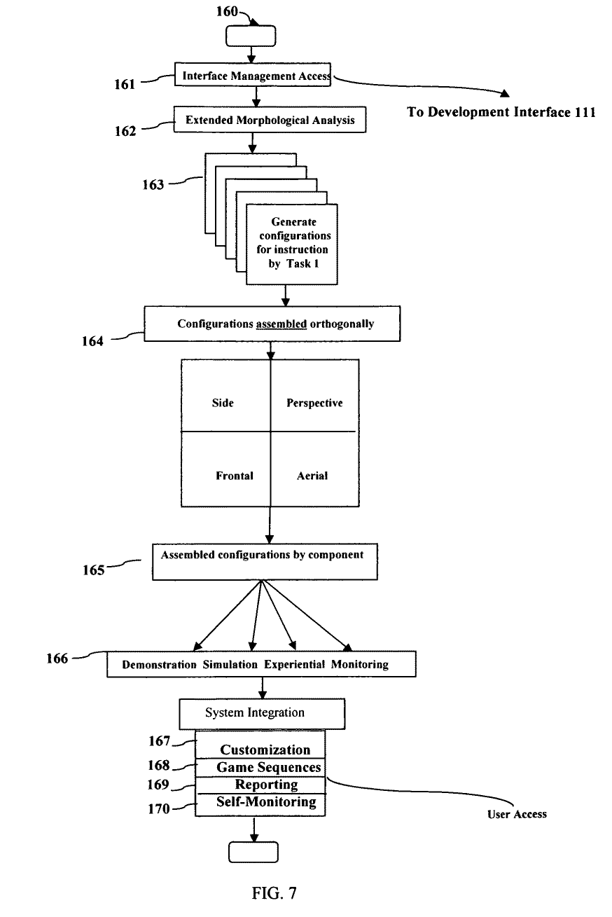

Referring to FIG. 7, at 160, where further morphological analysis intent for realization of a solution space, is the graphic development of the combinations of the path sets into required scenarios. The visualizations can be represented as: scientific animations and simulations or real-time interaction. Scientific animation is used to describe a more technically based presentation whereby objects and environments are properly and consistently scaled and trajectories and velocities are based on the laws of physics and the appropriate equations of motion. Simulations, also based on the laws of physics, contain specific underlying equations that can predict an outcome.

Further, in step 161, graphically prepared, animated and sound enhanced scenarios are integrated into instruction/game levels. Here, P1a-P10j, are provided by means of linking of vector coordinates within the modules within the n-dimension fields to vector coordinates in topological performance frames within the instruction/game tool and subsequent image replay in monitoring, real-time monitoring and record-keeping applications to signal communication.

Those with skill in the art will recognize, the current capability of graphic modeling, simulation and outsourcing practices that are employed to provide efficient yet effective graphic representation development. Vector-based modeling tools such as Autodesk Maya and Blender can be used to integrate, by means of their orthogonal formatting, subsets and primitives of the path set at level design. Interoperability of the transposed n-dimension arrays and matrices, are maximized by means of the orthogonal format of modeling programs where each dimension set of single task entry, is “reconfigured” within the core.

Here, frontal views are integrated with Demonstration levels at 2b,1, side and frontal views are linked with Simulation practice levels at 2b,2, perspective views are linked with Experiential levels at 2b,3, aerial or field map views are linked with Monitoring 2b4, and Real-time monitoring levels at 2b,5 and frontal, side and inverse frontal views are linked with Record-keeping levels at 2b,6.

The resultant core architecture is the framework for generation of transfer-to-practice tools. Common to the illustrated modules is the execution and intersystem sub-routines. Here, all instruction/game tools initiate sub-routines that access the RMK30 at 32, as mapped to 2b,1, 2b,2, 2b,c, 2b,4, 2b,5, 2b,6, where rendering of object(s), pertaining to the user (in this example, the retail terminal station at FIG. 6B) is carried out in the RMK 30 at 401. The review of virtual resource accessed in the RMK30 at 34 and 35, where object verification maps to 3d,1 and 3d,2, loss maps to 6f,1,6f,2,6f,3,6f,4, and 7g,1,7g,2,7g,3,7g,4, respectively linked to status 36 for modifications or variance review.

The following description is of the various modes and aforementioned features that are herein incorporated for providing a tiered-level approach for determined and variant, pre-a priori, a priori and a posteriori detection and notification during instruction execution. The intent of the level approach is transitory, whereby a learner/user in a pre-a priori state is supported through levels of a priori to a posteriori status during an instruction phase (i.e. 300, 400, 500, 600) within one embodiment of a compliance lifecycle period 1200.

To support this transitioning status, interoperable buffers for instruction-to-execution iteration are integrated within FIG. 8A-FIG. 8C at 1200. Dedicated buffers activate upon a variance (as determined by variance, resource loss and/or noncompliance) to a pre-assignment during a relevant instruction 300, 400, 500, 600, should an a posteriori status (defined as a virtual experience gaining status), regress to a priori status (defined as a knowledge gaining status), an instruction-to-execution iteration re-instructs the a priori user to regain a transitioning a posteriori status.

Upon which time, a user status has successfully transitioned through levels 300-600 at 1200, in FIG. 8A-FIG. 8C, to an a posteriori status; the user can continue to enable buffer activation for variance prevention as the user executes an actual operations instructions.

Here, phases 800 and 900 in FIG. 8C, can be accessed by the a posteriori user when assistance is required before or during monitoring, recording and user-specific instruction tasks during operations implementation. In addition, modified versions of 300, 400, 500, 600 in FIG. 8A-FIG. 8B, can transform into post-instruction testing (e.g. for use in certification or re-training verification). Thus, during an instruction task execution, integrated buffers can be enabled by the user to provide an instruction-execution iteration (FIG. 8A-FIG. 8C) where an a posteriori user status that regresses to an a priori status (as determined by variance, resource loss and/or noncompliance) can be re-established by means of a buffer designed for an execution-to-instruction-to-execution iteration.

User functionality of buffer (where circular buffers may be incorporated), iterations at FIG. 8A-FIG. 8C, are for, memory (301, 302, 303, 320, 401, 403, 404, 407, 415, 419, 502, 507, 511, 512, 517, 518, 520, 607, 609, 613, 802, 806, 812, 907 and 1103; decision (311, 318, 322, 323, 408, 412, 414, 418, 501, 516, 519, 519, 602, 611, 614, 802, 806, 814, 1101, 1104, 1107; and response (312, 316, 324, 401, 402, 410, 413, 421, 504, 505, 506, 507, 514, 515, 520, 608, 616, 807, 808, 812, 905, 906, 908, 101, 1105, 1108.

Instruction-to-execution processing is illustrated at FIGS. 8A-C. The instruction/game mode is illustrated at 400, 500, 700 and 1100, followed by operational modes for operational reporting 800 self-monitoring 900 and temporary use instruction 1100.

Referring to 500 in FIG. 8B, is a compliance lifecycle schematic for instruction-to-execution processing for the demonstration module. Instruction delivery begins by means of a prompt to identify and select a demonstration processing task (s) 404 and a correlated cinematic 405.

Cinematic presentations within the demonstration level correlate with cognitive constructs P2,0 within the core and integrate static 3c,1 and/or dynamic 3c,2 graphic object representations by means of object rendering, range of motion hand gestures P4d,0 and signal communication, P9,0. The cinematic provides a priori knowledge, by using cutaways and hand maneuvers and gestures illustrating step-by step task instructions that are subsequently measured using knowledge recall, transfer and mental effort algorithm sets for performance assessment.

Observational learning begins with a demonstration of the procedure/task requirements. Through cinematics (short sequences that contribute to the in-game plot by means of object cutaways that selectively make internal 3-D features visible, as illustrated in FIGS. 5A and 5B at “Cutaway”) and tips and strategies for achieving transfer-to-practice conformance objectives are provided. The cinematics are developed in particularly, for the “demo mode” of the instruction/game tool which does not involve user/learner/player interaction. Consistent with the, premise of the “demo mode,” the intention is to motivate and increase implicit instruction for task to execution.

The goal for the observational learning sequence is to correctly select required site specific object specifications. The strategy for achieving this goal is to identify information on such requirements as monitoring schedules and appropriate testing techniques and devices. Cognitive processes (CC) that can support the primary objective in Level 1 (Demonstration), regarding implicit transfer is understanding, integrate (CC1=exemplify, CC2=infer, CC3=explain, CC4=summarize, CC5=interpret, CC6=classify, and CC7=compare), required tasks/procedures to create Level 1 scenarios. The technique for incorporating the cognitive processes herein, is visual cueing by means of hand maneuvers with object interaction and gestures correlated with auditory syntax (i.e. incremental pointing gesture when summarizing step-by-step instructions) during instruction/game mode.

At the conclusion of the Release Detection cinematic an assessment prompt 406 activating recall 407 and 407 transfer to practice identification is presented to the leaner/user/player requesting (for exemplary purposes), the step-by-step specifications (instructions) by task and procedures. For example, the following instructions for ICTTT procedures include: (A) You must use this combination up to 10 years following installation of a new tank; (B) For inventory control, you must take inventory and dispenser readings and record numbers daily when product is added or removed; (C) Reconcile deliveries with delivery receipts by taking inventory readings before and after each delivery; (D) You must reconcile these numbers at least once a month and record your results. (EPA 510-R-04-003, pg. 24)

Variance detection of a priori knowledge analysis 411 pertaining to a determined 411 or variant 412, as compared to the determined instructions 404, regarding recall identification 407 or transfer assessment 408; results in automatic direction 413 to a new cinematic at 404 if no variance or automatic direction at 414 if a variance was detected. Computations of variance and transitioning status (transfer and cognition determination) is further computed with the tallies of variance performance and learner cognitive difficulty notation.

For exemplary purposes, when no variance 414 or subsequent loss P6f,0, is detected after a user/learner performance at P5e,0 and the status of resources loss at 38 in the RMK 31 remains unchanged. If on the other hand, specification selections had been identified as variant (5e,1, 5e,2, or 5e,3), probable non-conformance would have been determined. Specifications that do not meet requirements, synchronously activate memory buffer 401 which renders RMK 31 to display results of the performance P5e,0 and activate a user/learner response 40 buffer while waiting for user input 409 for a viewing cinematic repetition presentation.

Iterative feedback tracking for system integrity as well as needs assessment for learner/users. For example, repeat viewing 409 reinitiates the prior instruction loop 405.

A second module providing Practice and Interactive testing capabilities is presented at 500. The goal for the simulation mode is to acquire baseline a posteriori experience by replicating task procedures that correlate to learning or skill and an assessment of that acquisition by means of a testing mode.

Cognitive processes (CC) that can support the primary objective in Level 2, are (CC8=differentiate, (CC9=organize, CC10=attribute, CC11=checking, CC12=critique). The technique for incorporating the cognitive processes herein, is visual cueing by means of hand maneuvers with object interaction and gestures correlated with auditory syntax (i.e. incremental range of motion between two objects and “balancing” gestures successive range of motion between two object, the sequential range of motion lining up objects, the duplication of range of motion of and repetition of steps of a an practice, a practice technique range with two hands when summarizing step-by-step instructions)

Referring now to FIG. 8C, there is shown at 500 a flow process of instruction practice during a state of procedural and task execution. The state is initiated 500A by displaying a representation of learner/user specific objects in the RMK 30 as illustrated in FIG. 6B.

A prompt occurs to select a procedure 501 and task hierarchy of practice 502 from the Procedure/Task categories listed in the RMK 30 at 33. At 503, execution of fixed equipment/component objects within the training/testing space is correlated with path constraints of the (CCM) critical chain methodology in 101I.

At 504, performance is processed using an evaluation algorithm to determine a variance from a preferred practice and the type and gravity (>0.10), herein no variance or specifically, inaccurate, inappropriate, or untimely. No variance performances 505 meets all the mandatory requirements 506 (i.e. for the exemplary example of USTs) and processed in probable conformance 507. Inaccurate, inappropriate or untimely performances 508, 509 and 510 respectively, are processed to be in nonconformance 511 due to instructions for procedural steps not being followed.

Responses to correct probable non-conformance are prompted for 512. Here the learner/player can repeat the practice 513 and correct the previous performance executed 513 and is given up to two “tries” 514 accomplish the correction. After two “tries” an automatic correction 515 of the instruction is reprocessed 503 to replay. If on the other hand the practice was processed as correct, 505, repetition of the correct practice can process indefinitely 505.

At 518, a prompt regarding the completion of the specific instruction practice is displayed and the option of returning 519 to the execute a new practice replication 501 or 502. Warnings of loss are processed 520 and displayed in the RMK 31.

Completion of the simulation is re-prompted 518 to end the mode in 523 or access to further system states 524.

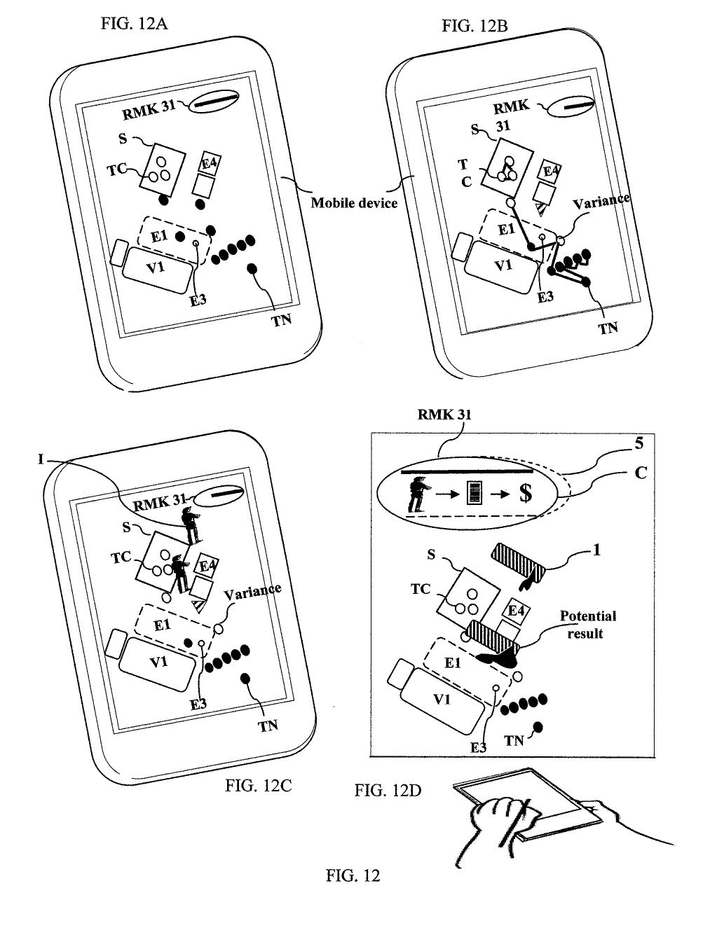

An example, of one embodiment of the practice mode is shown at FIG. 12 by means of an illustration of a field map identifying the location and practice order of the iconic representations of the 14 task maneuvers that include requirements and/or “best practices” for UST product delivery (EPA 510-R-04-003, pg. 88).

The iconic representations are provided to assist the learner/player/user, by means of a “topological map to navigate by” to help establish a mental model pathways of the for the requirements for implicit transfer practice of the instructions at hand.

The instructions for the procedure here include:

(1) Review and understand the spill response procedures. (2) Have an accurate tank capacity chart available for the delivery person. (3) Make sure spill response supplies are available in case a spill or overfill occurs. (4) Make sure there is adequate lighting around the delivery area. (5) Make sure the delivery person knows the type of overfill device present at the tank and what actions to perform if it activates. For example, post a sign where the delivery person will see it. (6) Make sure the spill bucket is empty, clean, and will contain spills. (7) Make sure there are safety barriers around the delivery area. (8) Determine and record accurate readings for product and water in the tank before product delivery. (9) Have a person responsible for monitoring the delivery available each time tanks are being filled; the delivery person makes all hook-ups. (10) Have a person available to monitor the disconnection of hook-ups following delivery; the delivery person disconnects the hook-ups. (11) Determine and record accurate readings for product and water in the tank after delivery. (12) Verify the amount of product received. (13) Make sure fill ports are properly secured. (14) Make sure the spill bucket is free of product and clean up any small spills (EPA 510-R-04-003, pg. 88).

If variance had been detected, performance would be reflected by a warning of probable non-conformance through the notification (i.e. blinking) as shown in the RMK at 31a.

The goal during the experiential mode is to transfer the instruction to practice and to accurately, appropriately, and timely respond to the results and consequences. The strategy is to skillfully maintain resources and prevent any loss of human, environmental, property or third-party financial assets. Cognitive processes (CC) that can support the primary objective in Level 3 (Experiential), are Creation and Application (CC13=hypothesis generation, CC14=planning, CC15=implementing plan, CC16=executing task, CC17=implementing). The technique for incorporating the cognitive processes herein, is visual cueing by means of hand maneuvers with object interaction and gestures correlated with auditory syntax (i.e. range of motion between computer or documentation objects a priori to instruction (to denote planning and hypothesis), and range of motion between computer or documentation objects a posteriori to denote cause and effect mode.

FIG. 8C at 600, initiates the experiential mode for experiencing the determined and variant visualization of procedures and tasks.

Upon activation, an experiential scenario is executed 603. In addition, to interface commands that continue to activate fixed objects 503, the combination also now triggers virtual ranges of motion (i.e. walking, running, climbing and jumping) 604. Execution of task performance by means of interaction and responses with objects, characters, performance and consequences, are processed 606 to portray actual effects 607.

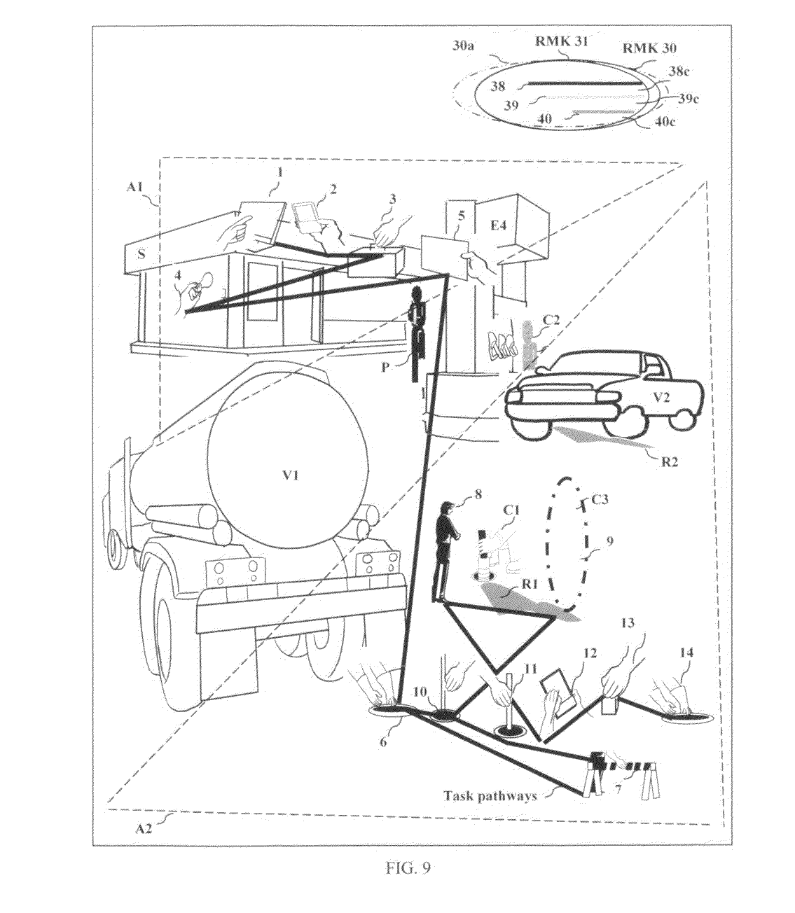

FIG. 9, is an illustration of the same scenario space after a learner/player/user execution, whereby a variance is detected at 608 through an overlay of the field map. In FIG. 9 required tasks are identified and the variance of instruction, incidents that may have occurred and the responsible parties are presented in an topological performance chart. Each of the 14 task procedures, represented by iconic representation, are processed within 2 action zones (abbreviated with symbols “A1” and “A2” respectively within the figure). The processing results of the performance is displayed in the RMK 31, which triggers a warning notification at 520. The warning is regarding monetary deductions for probable nonconformance and the subsequent potential for loss.

Acceptable responses are to alter or re-execute the performance to avert the adverse consequences. Altering the performance 611 requires re-performing the instructions for the tasks 607, to avert a variance at 612 which then is processed to super cede a non-conformant state (i.e. 508-510). If variance is averted 612 automatic processing of requirements met 613 and prompting 614 to return to next scenario 601. No attempt to alter the variance 615 retains a noncompliant state 616 and subsequently prompts a loss warning 520 as displayed in the RMK 521. Further processing initiates the log time of the error 617, causing a random number generation of the incident to reoccur at a later time 618.

At the completion of a scenario, a variance in performance is assessed at 608. If no detection of variance 608 in performance of instructions 609 the assessment processing 610 is probable conformance.

For exemplary purposes, the processing of the performance detects a variance 608, assessed to be inaccurate 508 and is processed 511 to not conform. Prompting occurs 512, to review the inadequacies of the previous performances 508 and respond 512.

FIG. 10A, shows an illustration of a zoom-in scene illustration of character object “C1” and consequences. In the exemplary embodiment, adverse effects from an overfill by “C1” (the delivery person} have resulted in a release of product onto the ground. The RMK 31 reflects a recession in the line 37 to the right denoting financial losses to the learn/user/user. Additional costs are also computed to incur as the result of product clean-up from both the “C1” and “C2” (the customer). The illustration of the RMK 31, displays the tracking and computation processing 520 of resource loss in lanes 37c, 38c and 39c where loss for probable errors are predicted to result in consequences and loss.

As illustrated in FIG. 10B, two unexpected product releases have occurred. In that the errors have resulted in a product release to the environment, three of the virtual resource displays, regarding personal finance 37 and third-party 38 financial loss and environmental harm 39, appear in the RMK 31. To view an explanation of the resource loss the learner/user/player interacts with the respective lines, to access lanes 37c, 38c and 39c. Each lane is a swim lane detection and tracking of variances at 407, 504, 608, 612, 806, 905, 1108 at 520, computation and loss correlation within the core and presented for access by means of the RMK 30 and 31 at 521 interfaces.

A prompt regarding a return to the next scenario 614 directs the learner/player/user to 601. If no further interaction in this mode is required, access to other modes is carried out 524 or ending the module 523.

Further, instruction for specific operations such as monitoring, real-time monitoring and recordkeeping are integrated within practice and experiential modes by means of the following cognitive construct dimensions. Level 4 (Monitoring) task transfer to practice incorporate, (CC)=recall and (CC)=remember). Level 5 (Real-time self-monitoring) and Level 6 (Reporting) task transfer to practice, incorporate meta-cognitive dimensions in which all cognitive processes are integrated.

A flow chart process at 800, in FIG. 8A describes the reporting module for using site-specific images (abbreviated as symbol “X” in the [[figure]] FIG. 5) and supplemental resources to complete a reporting. form.

At 801 in FIG. 8A, a prompt activation is made regarding whether or not support is required for processing reporting requirements subsequent to the retrieval of a reporting form at 800A. If assistance is necessary, the user can retrieve and load site-specific equipment images at 802 and specifications previously identified and stored within the core at 307.

In one or more embodiments, the site-specific equipment images in 307 are pre-stored in XML compatible formats (i.e. SXML). In such embodiments, universally unique identifiers (UUIDs) and other such signatures (i.e. IDDI) matched to the site-specific equipment images with the exact mandatory requirement request. Pre-assigned UUIDs uniquely identifying object data linked to P3,0-P3,2, within the forms such at entry-point vectors, at 307, are used to verify at 803, the stored image with the requirement as mapped to the form.

In one exemplary embodiment, if the user is unsure of the settings of the overfill restrictions (not assigned at 322-329), for required equipment, access 805 to animation resources 405 (abbreviated as symbol “A” in FIG. 11) is automated to clarify and or explain information requirements directly within the electronic format.

For example, FIG. 11, shows an illustration of the incorporation of site-specific equipment images and resource links within a reporting form (abbreviated as symbol “F” in FIG. 4. If the user requires further assistance, the user can be directed to practice replication at 400, or other instruction/game tool states at 417.

As the user interacts with the form and enters information not consistent, variance prompts at 806, process with a pre-assigned format at 307 and notification at 807, (with pre-assigned preferences from 327 and 328), providing opportunities for error correction. If the data form, is processed with no variances at 806 and complete at 808, an interaction prompt occurs at 809 for documentation assignment. Draft at 810 or completed file to save at 811 is stored to memory, or send at 811 to a respective receiver, processed in accordance with output configuration at “O”, to a respective hardware and operating environment illustrated in FIG. 1. All transactions subsequently are routed through the RMK for output. If no further reporting processing is executed, the module ends at 813.

FIG. 12A, shows a state at 900, for instruction assisted self-monitoring of required procedures and tasks. As the setting of self-monitoring practice or advisory mode is conducted in real-time, detailed schematics as depicted in FIG. 9, while accessible, are not required, in that the user is assumed to have transitioned from a priori to an a posteriori upon the successful completion of the Experiential level.

Notification customization can be initiated at 323 regarding the pre-assignment of support and constraints at 324, for]procedure/task scheduling of date and time at 325 preferred method of notification where the user is prompted at 326-328 setting quantity measures, method of notification delivery, and message type and content preferences.

For example in FIG. 12D, when preparing for monitoring in real-time, the notification preferences can be corresponded to digital image retrieval. As illustrated, imports of image files at FIG. 8A at 304, from an image (which can include communication signals from (A) digital, (B) laser, (C) radio microwave, or (D) bar code) preferences and are analyzed as to whether the transferred image needs to correspond to the stored equivalent image at 310 and/or pre-assigned quantity parameters at 326.

If parameters pre-assigned restrictions, notification (to the user or other) can be triggered from 327. If on the other hand parameters are exceeded or are about to be exceeded, notification can be provided with signal communication from 328, to serve as an intermediate intervention to the pre-assigned parameter restriction set at 326 stored to memory at 329.

Further verification prompting at 903, for notification at 325 and 326 and notification preferences at 327 and 328 is carried out for signal communication. At 325, either sound, telephone callback or both sequential notification can be used as notification of all requirements. At 904, the user executes self-monitoring implementation. The processing steps follow those of 600-623, where modifications to the experiential state integrate performance processing. An illustration of self-monitoring processing on a mobile device following steps 601-622 are herein described in FIG. 7A-FIG. 7D.

Returning to FIG. 8A at 900, At 901, self-monitoring for assigned task instruction execution, appear on visualization medium (in this example, the screen of a device). For exemplary purposes, to illustrate this processing method, required instructions are presented for a product delivery scenario as illustrated in FIG. 7A. The schematics in the field map serve as a mental model and topological “map to navigate by” for implicit transfer of the 14 required tasks, required in executing the delivery product procedure illustrated in FIG. 13.

Access at 901, is provided to a user, for pre-assigned topological performance field maps and aerial view site-specific images (static or dynamic) at 310. Selections are automatically downloaded for utility at 902 where the user is prompted at 903 to verify the accompanying requirements that support site-specific field map instructions to be accessible (as it pertains to this exemplary embodiment), through a wireless or mobile device. The self-monitoring assignment is ready for execution at 904.

Processing of each instruction by task, progresses as the user designates that the task has been completed, by means of interaction with a user interface mapped to core by means of P9j,0 and relative objects, than can include: keying in instruction related number or tapping task through a touch screen, retrieving digital type image that is matched to an image previously retrieved during customization and that has been mapped to the user interface with the user's camera on user's cell phone, or receive sensor signal (i.e. infrared, laser and/or accelerometer) as configured.

At each interaction, performance at 905, is processed for variance detection at 907 against pre-assigned constraints at 908 by means of an evaluation algorithm, whereby each path set (for an instruction to carry out a task), exceeding a zero value, triggers variance detection at 907 and notification to user at 906, allowing the user to re-execute the instruction for the task.

FIGS. 12A-12D show illustrations of the self-monitoring module during a product delivery procedure. Structural objects, transportation vehicle character, tasks and paths in the field map are abbreviated as “S” station, dispenser “E4”, tank “E1”, port “E3”, “V1” for the delivery truck, “C3” for character, “V” for variance, “TN” task not complete are unfilled circles, “TC” Task completed are filled circles.

Referring to FIG. 12A, there is shown an illustration of the incorporated topological map (to navigate by) for self-monitoring rendered at 902. The automatic retrival of site-specific images at 309, links to self-monitoring objectives pre-assigned at 324-329, correlated with the processing hierarchy at 33 at “Z”, in signal communication with a wireless device. FIG. 12B, shows an illustration of the variance detection at 907, of the executed instructions that are performed out of sequence or are not performed at all, whereby variance triggers (i.e. visual 327 and audio 328) notification to user.

If a variance during instruction execution goes unaddressed for more than a pre-assigned time, the potential problem (5) that may result is rendered into the resource key. FIG. 24C, shows an animated which displays until the task is noted as being complete.

Referring now to FIG. 12D, there is shown an iconic representation of the signage and a leaking tank in accordance with an exemplary embodiment of the present invention. In that the user has indicated further notification through a call-back, the user's wireless device pre-assigned recorded personal message as to the consequence gravity. For example in the present example, the pre-recorded message the user has assigned to his or her self is, “Remember, to change signage to note new equipment upgrade.” If the user does not address either of the incomplete tasks, they will continue to notify the user in accordance with pre-assigned interval.

Returning to FIG. 8A, a prompt a query to the user for data form or task/file status at 907 and 808 and assigned constraints. Instructions not followed or task incompletion is directed to 904 for re-execution. Documentation processing is directed to 809 for processing and module ending at 813.

Instruction/Game Tool Strategy

The general provision of instructional information appears to have been limited in the ability to transfer conformance to practice. However, technology enhanced benefits of utilizing pedagogic principles within multimedia instruction or multimodal learning incorporated into a 3-D game tool presents opportunities to enhance implicit transfer to practice.

Empirical research has reported that games have been found to provide a more meaningful environment for problem-based learning. As problem solving can be associated with discovery learning, synthetic environments such as game tools, allow users to discover new rules and ideas rather than memorizing or forgetting information. As it pertains to this invention, these opportunities can include: intuitive communication of risks, faster retention of procedures and tasks and increased validation of policy or law in that self-evaluative reactions brought about by consequential results enhance reasoning. Significantly, successfully immersing instructional material into an electronic game without disturbing the inherent features and concepts of game play, is believed capable of transforming games into a channel for information dissemination.

The disclosed process as integrated includes: demonstrations, practice simulations, experiential, monitoring, real-time and recording instruction/game tool scenarios that portray effects of actual consequential effects and results from learner/player (hereafter learner) responses and the addition of an executable self-monitoring and recordkeeping/reporting application. Learners that perform or respond inaccurately, inappropriate or untimely within the learning applications, may loose virtual resources as the result of unplanned consequences that can include: fines, job loss, shut-downs or incarceration or expend public dollars through emergency support resources. In addition, third-party costs resulting from harm to humans and the environment or other resources as appropriate to the specific learning domain are also tallied.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method comprising:
generating an instructional game through extended morphological field analysis of instructional game parameters;
providing support to a compliance learner as they encounter variance during instruction to operational execution, redirection or intervention; and
necessitating a metric for transfer during and within an instructional compliance lifecycle relative to rules of law, policy, codes, standards of treatment, and/or self-assigned parameters.

2. A system comprising:
generating an instructional game through extended morphological field analysis of instructional game parameters;
providing support to a compliance learner as they encounter variance during instruction to operational execution, redirection or intervention; and
necessitating a metric for transfer during and within an instructional compliance lifecycle relative to rules of law, policy, codes, standards of treatment and/or self-assigned parameters.

3. A system comprising: asynchronous means:
generating an instructional game through extended morphological field analysis of instructional game parameters;
providing support to an entity encountering variance during instruction to operational execution, redirection or intervention; and
necessitating a metric for transfer during and within an instructional compliance lifecycle relative to rules of law, policy, codes, standards and self-assigned parameters.
